(19) United States
(12) Patent Application Publication
(10) Pub. No.: US 2007/0245364 A1
(43) Pub. Date: Oct. 18, 2007

(54) Disk device

(75) Inventor: Daisuke Tanaka, Daito (JP)

Correspondence Address: BACON & THOMAS, PLLC, 625 SLATERS LANE, FOURTH FLOOR, ALEXANDRIA, VA, 22314, US

(73) Assignee: FUNAI Electric Co., Ltd., Daito (JP)

(21) Appl. No.: 11/785,280

(22) Filed: Apr. 17, 2007

(30) Foreign Application Priority Data
Apr. 18, 2006 (JP) 2006-114871

(51) Int. Cl. G11B 7/00; G11B 33/08

(52) U.S. Cl. 720/692; 720/651

(57) ABSTRACT

Disclosed is a disc device of which main body is accommodated within a housing. Engaging pieces 19 are provided in the rear of two rear side supporting stands 14b and 14d on a bottom chassis 2a of a housing 2. Each of the engaging pieces 19 is formed in an L-shape and is composed of a vertical plate 19a integrally provided in the rear of the rear side supporting stands 14b or 14d on the bottom chassis 2a to project vertically therefrom and a horizontal plate 19b bent at right angle at the distal end of the vertical plate 19a and extending to the above of each supporting stand 14b or 14d. Front side supporting stands 14a and 14c are formed with a screw hole 1. Foot portions 13a to 13d provided on a disc device main body are respectively put on the supporting stands 14a to 14d and slid over the same, allowing rear side foot portions 13b and 13d to engage the engaging pieces 19, and screws are passed through respective through holes of front side foot portions 13a and 13c and are threaded into screw holes of front side supporting stands 13a and 13c so that the disc device main body 1 is fixed at a predetermined position within a housing 2.

### BACKGROUND OF THE INVENTION

1. Field of the Invention

The present invention relates to a disk device such as a DVD player and DVD recorder for reproducing data from, recording data to and/or erasing data from a disk, and more particularly relates to a structure for mounting a main body of the disk device in a housing which accommodates the main body.

2. Description of the Prior Art

A Japanese Unexamined Patent Application Publication No. 2003-109370 discloses a structure in which a base unit is put into an outer housing and screws are passed through respective through holes formed in the base unit and threaded to a bottom portion of the housing to fix the base unit within the housing.

A disk device which has been on the market has a structure such as shown in FIGS. 14 and 15. The disk device main body 1 of the marketed device is located at a predetermined position within a housing 2 which is made of synthetic resin material and composed of a bottom chassis 2a, a top chassis 2b and a front panel 2c formed with a disk take-out slot.

The disk device main body 1 includes a loader chassis 6 made of synthetic resin material and adapted for supporting a tray 5 on which a disk D is to be mounted, with the tray 5 being movable back and forth as shown by arrows a and b. The disk device main body 1 further includes an optical pickup 7 provided with an objective lens OL and a turn table 8 which are mounted on a traverse chassis (not shown) movable up and down within the loader chassis 6, and a damper 10 disposed within a central container portion 9a of a transverse beam 9 bridged between both side walls 6a of the loader chassis 6 such that the damper may move up and down within a predetermined range. At a play mode, the disk D is clamped by the turn table 8 and the damper 10 and is rotated at high speed by the turn table such that information recorded on the disk D is read by the optical pickup 7 for the reproduction, recording and/or erasing of the information.

Four leg portions 12a to 12d are provided on both side walls 6a of the loader chassis 6 integrally therewith, with the four legs beings spaced from each other by respective predetermined distances and projecting respectively from the side walls 6a. Each of the leg portions 12a to 12d is formed with a foot portion 13a, 13b, 13c or 13d which bends at right angle at a distal end of the leg portion. The bottom chassis includes four supporting stands 14a to 14d which is integrally provided with the bottom chassis to project therefrom and against which the foot portions 13a to 13d are to respectively abut, with corresponding supporting stand and foot portion being in alignment with each other when the disc device main body 1 is installed within the housing 2. The foot portions 13a to 13d are respectively fixed on the supporting stands 14a to 14d by screws 17 which pass through respective through holes 15 of the foot portions 13a to 13d and are threaded into screw holes 16, thereby fixing the disk device main body 1 to the housing 2.

The above mentioned structure of the marketed device employs four screws 14 for fixing the loader chassis 6 to the housing 2 and the number of the screws 17 is so many as to increase the cost of the device and lower the working efficiency in its assembling work since the device requires much time and manpower for the threading operation. The device disclosed in the Japanese Unexamined Patent Application Publication also has the same problem since screws are used for fixing the base plate on the outer housing.

### SUMMARY OF THE INVENTION

In view of the problem of the conventional devices as mentioned above, an object of the present invention is to provide a disk device which can be manufactured at low cost and can be assembled with improved efficiency.

To attain the above mentioned object, a disk device according to the present invention comprises a disc device main body for reproducing data from, recording data to and/or erasing data from a disk and including a loader chassis of synthetic resin material and four leg portions provided on the loader chassis integrally therewith, each of the leg portion having a foot portion bent at the distal end of the leg portion at right angle and the leg portions being spaced from each other by predetermined distances and projecting from the loader chassis; and a housing of synthetic resin material adapted for accommodating the disc device main body, and including a bottom chassis integrally provided with four supporting stands projecting from the bottom chassis to be respectively engaged by and coupled to the foot portions to fix the disc device main body to the housing, wherein at least two of the four couplings of the foot portions and supporting stands are configured in a form of retaining coupling with which one of the foot portion and the supporting stand is fit into the other with relative movement of the disc device main body and the housing, to retain the foot portion in the supporting stand.

According to the structure of the present invention as mentioned above, the number of the screws can be reduced by the number of the retaining couplings, thereby lowering the manufacturing cost and improving the efficiency of assembling work.

### BRIEF DESCRIPTION OF THE DRAWINGS

FIG. 1 (a) is a partially cutout plan view of a disc device according to a first embodiment of the present invention, and FIG. 1 (b) is a partially cutout side view of the same,

FIG. 2 is an exploded perspective view of the disc device shown in FIG. 1,

FIG. 3 is a perspective view of a main part of the disc device shown in FIG. 1,

FIGS. 4 (a) and 4 (b) are side views for illustrating a process for assembling the disc device of the first embodiment,

FIG. 5 is a perspective view of a main part of a disc device according a second embodiment of the present invention,

FIG. 6 (a) is a partially cutout plan view of a disc device according to a third embodiment of the present invention, and FIG. 6 (b) is a partially cutout side view of the same,

FIG. 7 is a perspective view of a main part of the disc device according to the third embodiment of the present invention,

FIGS. 8 (a) and 8 (b) are side views for illustrating a process for assembling the disc device of the third embodiment,

FIG. 9 (a) is a partially cutout plan view of a disc device according to a fourth embodiment of the present invention, and FIG. 6 (b) is a partially cutout side view of the same,

FIG. 10 is an exploded perspective view of the disc device according to the fourth embodiment of the present invention,

FIGS. 11 (a) and 8 (b) are side views for illustrating a process for assembling the disc device of the fourth embodiment,

FIG. 12 (a) is a partially cutout plan view of a disc device according to a fifth embodiment of the present invention, and FIG. 12 (b) is a partially cutout side view of the same,

FIG. 13 is a partially cutout plan view of a disc device according to a sixth embodiment of the present invention,

FIG. 14 (a) is a partially cutout plan view of a conventional disc device and FIG. 14 (b) is a partially cutout side view of the same, and

FIG. 15 is an exploded perspective view of the conventional disc device shown in FIG. 14.

### DESCRIPTION OF THE PREFERRED EMBODIMENTS

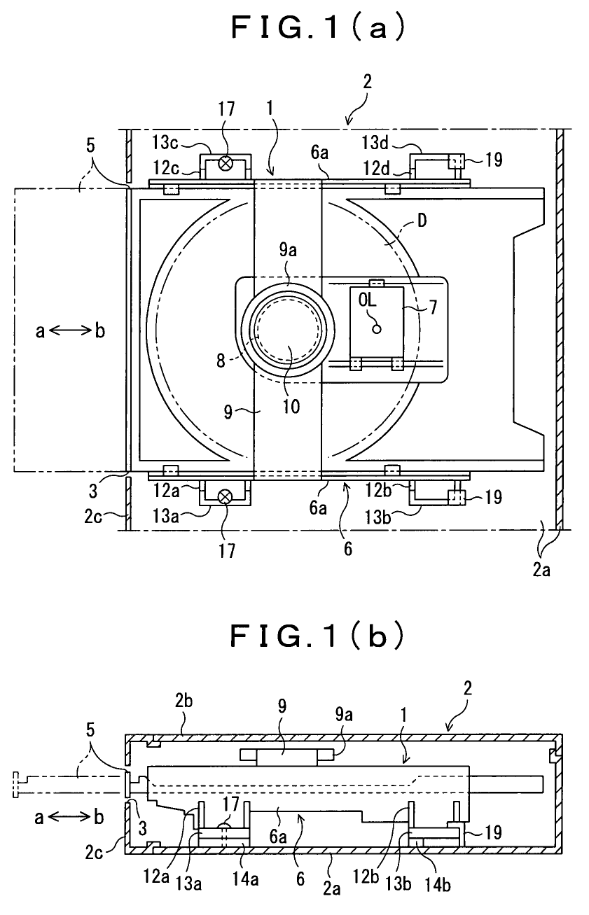

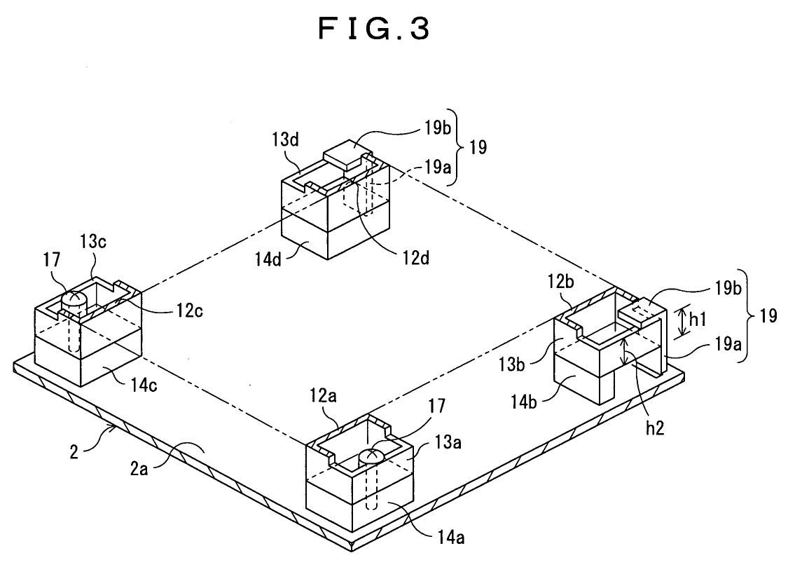

With reference to FIGS. 1 to 4 showing the first embodiment of the present invention, engaging pieces 19 are provided in the rear of two rear side supporting stands 14b and 14d of four supporting stands 14a through 14d integrally provided on a bottom chassis 2a to project therefrom.

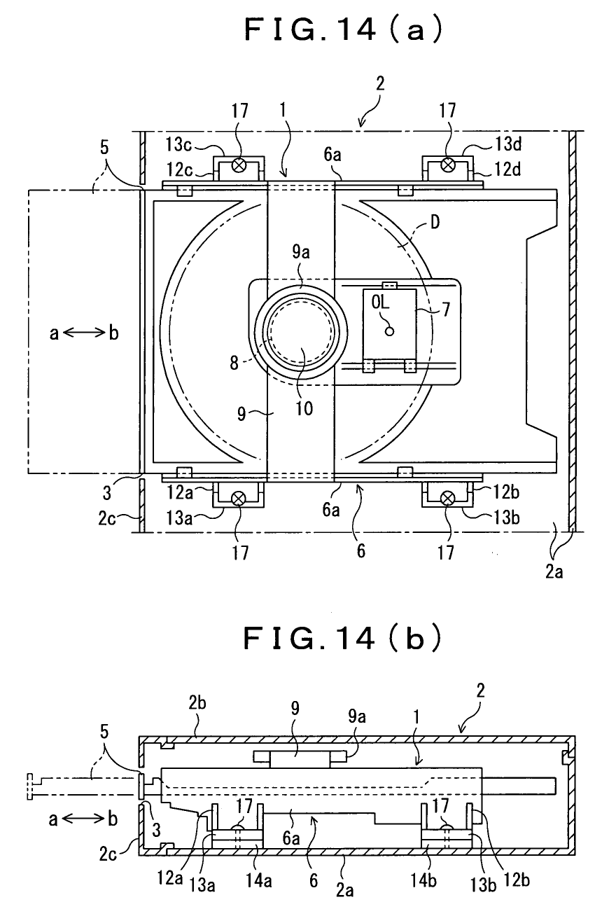

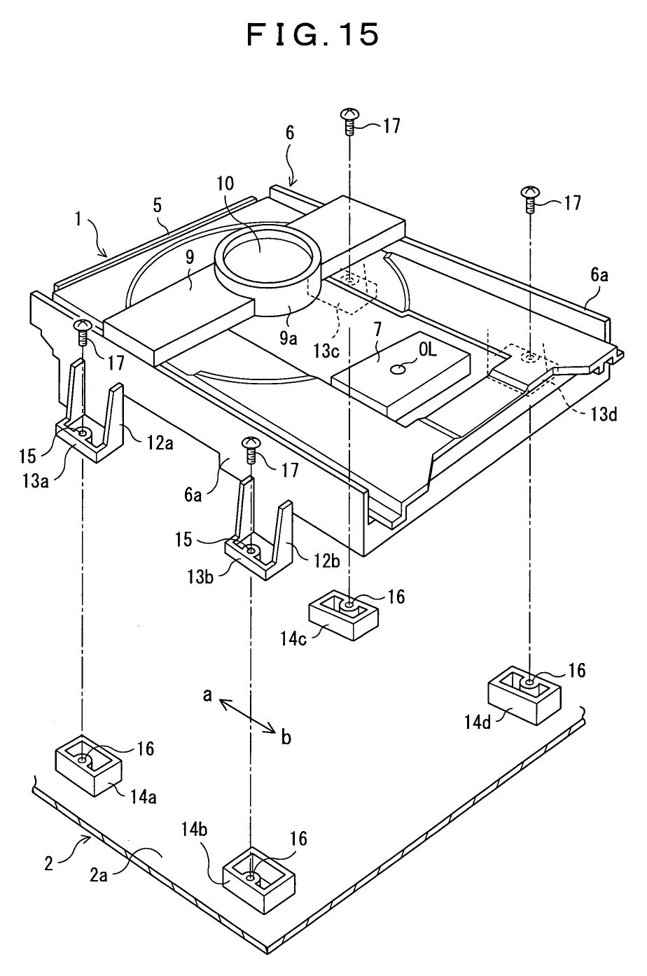

The present embodiment has substantially the same configuration as that of the disc device shown in FIGS. 14 and 15 except the above mentioned structure. Accordingly, the same or like reference numerals and marks are used for the same or similar elements in the drawing of the embodiment and description of substantially the same configuration will be omitted for the convenience.

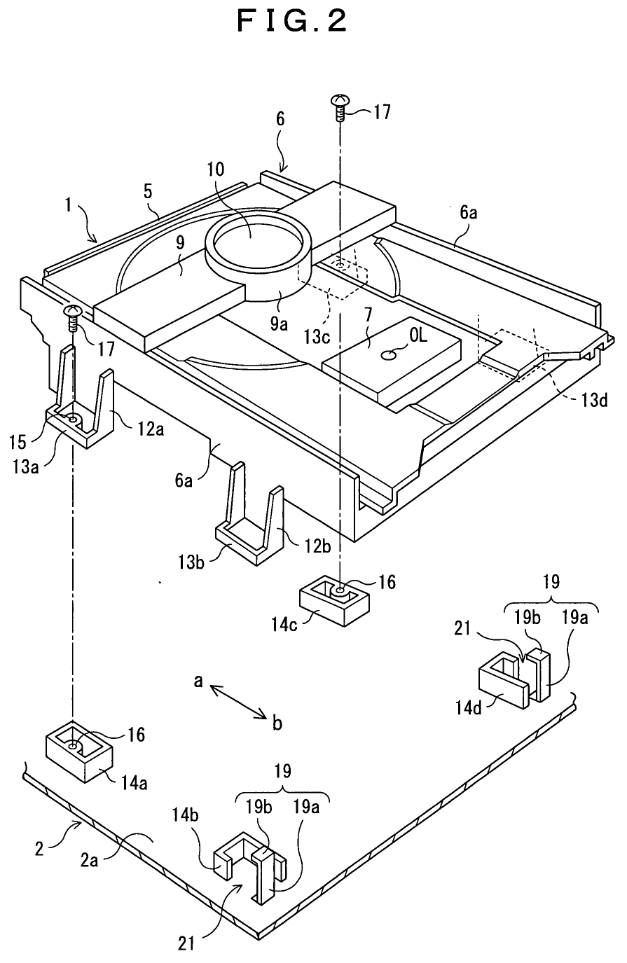

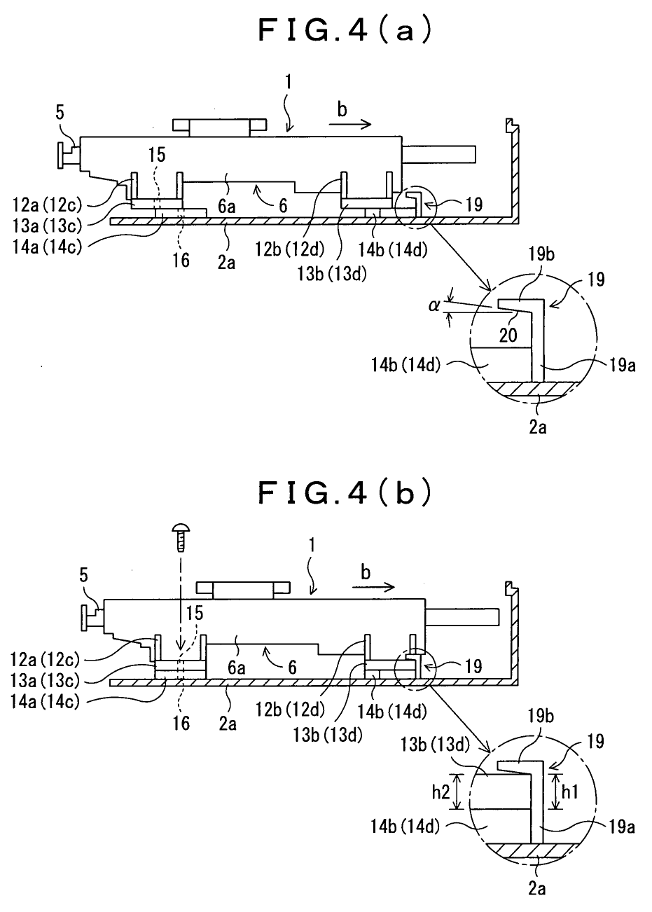

Each of the engaging pieces 19 is formed in a substantially L-shape and is composed of a vertical plate 19a integrally provided in the rear of the rear side supporting stands 14b or 14d on the bottom chassis 2a to project vertically therefrom and a horizontal plate 19b bent at right angle at the distal end of the vertical plate 19a and extending to the above of each supporting stand 14b or 14d. As shown in the enlarged view of FIG. 4 (b), the distance or spacing h1 between the bottom surface of the horizontal plate 19b of the engaging piece 19 and the top surface of the supporting stand 14b or 14d is set to be substantially equal to the height or thickness h2 of the foot portion, i.e. the horizontally bent portion. As shown in the enlarged view of FIG. 4 (a), the bottom surface 20 of the horizontal plate 19b may be inclined upward toward the distal end of the horizontal plate 19b by a small angle \acute{α} to facilitate insertion of the rear side foot portions 13b and 13d into the space between the horizontal plate 19b and the supporting stand. In this case, the distance or spacing h1 may be measured between the proximal end of the bottom surface of the horizontal plate 19b and the top surface of the supporting stand. As shown in FIG. 2, the rear side supporting stands 14b and 14d are formed with a cut out 21 in the vicinity of the engaging piece 19 to facilitate pulling out of the engaging pieces 19 from a mold.

Next, explanation will be made of a process for assembling the disc device of the configuration as described above. As shown in FIG. 4 (a), the foot portions 13a to 13d are put respectively on the supporting stands 14a to 14d with the foot portions 13a to 13d being displaced forward by a small distance from the positions in alignment with the supporting stands 14a to 14d, and then as shown in FIG. 4 (b), the disc device main body 1 is pushed rearward as shown by the arrow b allowing the foot portions 13a to 13d slide over the top surfaces of the supporting stands 14a to 14d such that the rear side foot portions 13b and 13d respectively engage the engaging pieces 19 to be received in the space between the bottom surface of the horizontal plate 19b of the engaging piece 19 and the top surface of the supporting stand 14b or 14d. Subsequently, screws 17 are passed through the respective through holes 15 of the front side foot portions 13a and 13c and threaded into the respective screw holes 16 of the front side supporting stands 14a and 14c to fix the disc device main body 1 at the predetermined position within the housing 2.

According to the above mentioned configuration, the number of the screws 17 is reduced from four of the conventional device to two of the embodiment, i.e. by the number of engaging pieces 19 so that the number of elements is reduced, resulting in reduction of manufacturing cost of the disc device. In addition, efficiency of assembling work is improved since the number of times of threading the screws 17 is lessened.

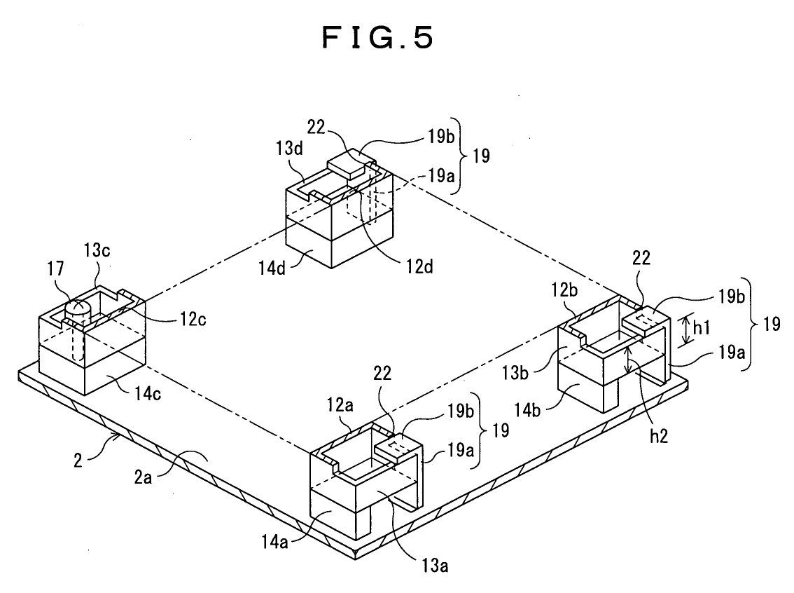

Although the first embodiment is configured such that the disc device main body 1 is fixed at predetermined position within the housing by means of two engaging pieces and two screws, the manner of the fixing is not limited to this. As in the second embodiment shown in FIG. 5, another engaging piece 19 may be added to the rear of one of the supporting stands 14a and 14c so that the disc device main body 1 may be fixed at predetermined position within the housing 2 by means of three engaging pieces and one screw. According to this configuration, only one screw is required for the fixing of the disc device main body so that manufacturing cost is further reduced and efficiency of assembling work is further improved. It is to be noted that each of the horizontal plates 19b is in contact with a side surface 22 of each leg portion 12a, 12b, 12c or 12d to certainly prevent the disc device 1 from swinging about the screw 17.

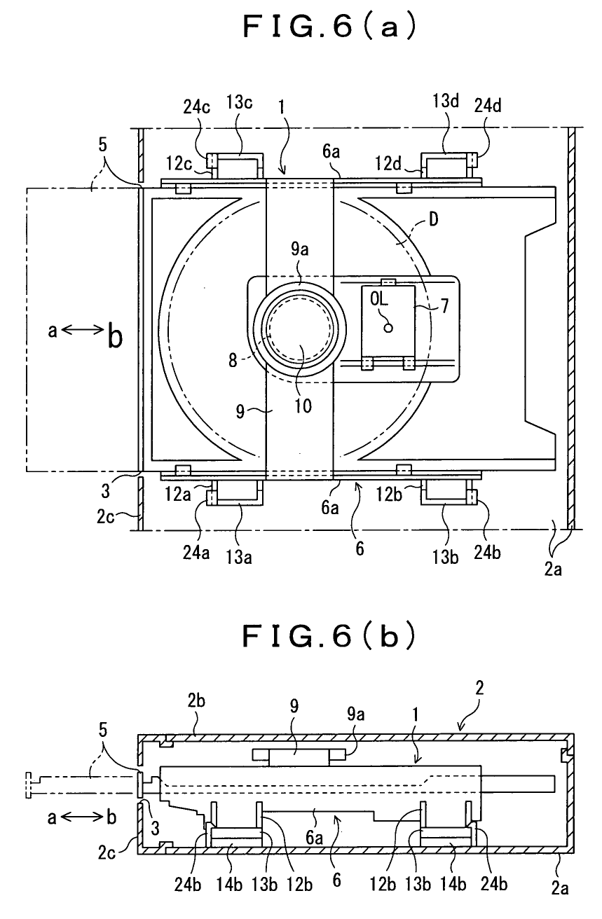

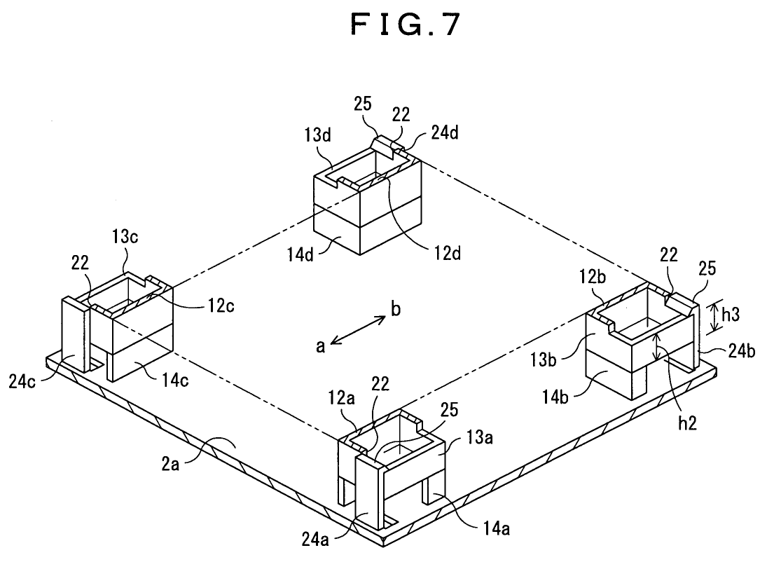

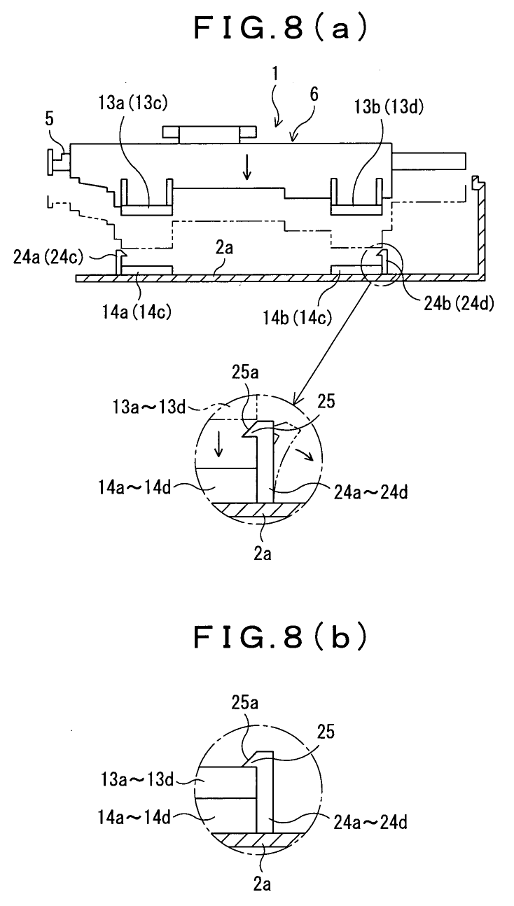

FIGS. 6 to 8 show a disc device according to a third embodiment of the present invention. The disc device is configured such that the disc device main body 1 is coupled with the housing 2, with the foot portions 13a to 13d being respectively mounted on the supporting stands 12a to 12d. In the device, elastically deformable front side hook 24a and 24c are integrally provided on the bottom chassis 2a to project therefrom such that their leg portions respectively extend along the front surfaces of the front side supporting stands 14a and 14c. Also, elastically deformable rear side hook 24b and 24d are integrally provided on the bottom chassis 2a to project therefrom such that their leg portions respectively extend along the rear surfaces of the rear side supporting stands 14b and 14d. Those hooks 24a to 24d project vertically and extend above the supporting stands 14a to 14d with their projecting tips 25 extending over the respective supporting stands and opposing each other in the direction shown by the arrows a and b in a manner that the projecting tip 25 of the hook 24a opposes the projecting tip 25 of the hook 24c and the projecting tip 25 of the hook 24b opposes the projecting tip of the hook 24d. The distance or spacing h3 between the bottom surface of each projecting tip 25 and the top surface of each supporting stand 14a to 14d is set to be substantially the same as the height or thickness h2 of each foot portion 13a to 13d. As shown in the enlarged view of FIG. 8, the top surface 25a of each projecting tip 25 may be inclined downward toward its end to facilitate engagement of each foot portion 13a, 13b, 13c or 13d to each hook 24a, 24b,24c or 24d. The third embodiment has substantially the same configuration as that of the first embodiment (see FIGS. 1 to 4) except the above mentioned structure. Accordingly, the same or like reference numerals and marks are used for the same or similar elements in the drawing of the embodiment and description of substantially the same configuration will be omitted for the convenience.

Next, explanation will be made of a process for assembling the disc device of the configuration as described above. As shown in FIG. 8 (a), the disc device main body 1 is pushed down with the foot portions 13a to 13d being respectively pushed against the projecting tips 25 of the hooks 24a to 24d so that the hooks 24a to 24d elastically deflect allowing the foot portions 13a to 13d to pass over the foot portions 13a to 13d which in turn are respectively mounted on the supporting stands 14a to 14d. Then, as shown in FIG. 8 (b), the projecting tip 25 of the hooks 24a to 24d engage the foot portions 13a to 13d to fix the disc device main body 1 at predetermined position within the housing 2. It is to be noted that rolling of the disc device main body is surely prevented by making the projecting tips 25 of the hooks 24a to 24d in contact with side surfaces of the leg portions 12a to 12d.

According to the configuration mentioned above, substantially the same effect as that of the first embodiment can be obtained. Especially, the third embodiment requires no screw for fixing the disc device main body 1 to the housing 2 so that manufacturing cost will be reduced and efficiency of assembling work is further improved.

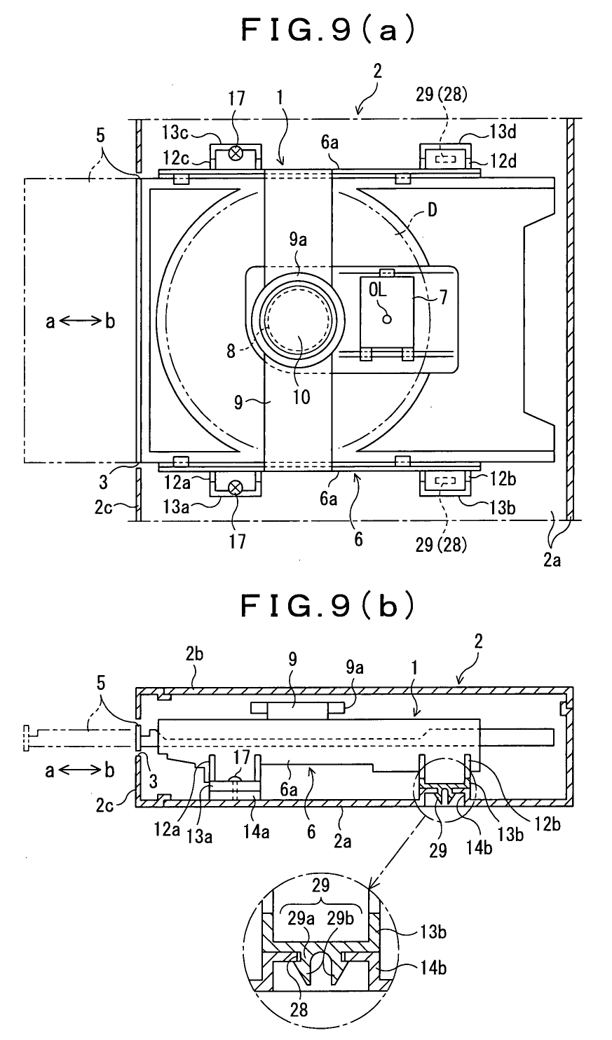

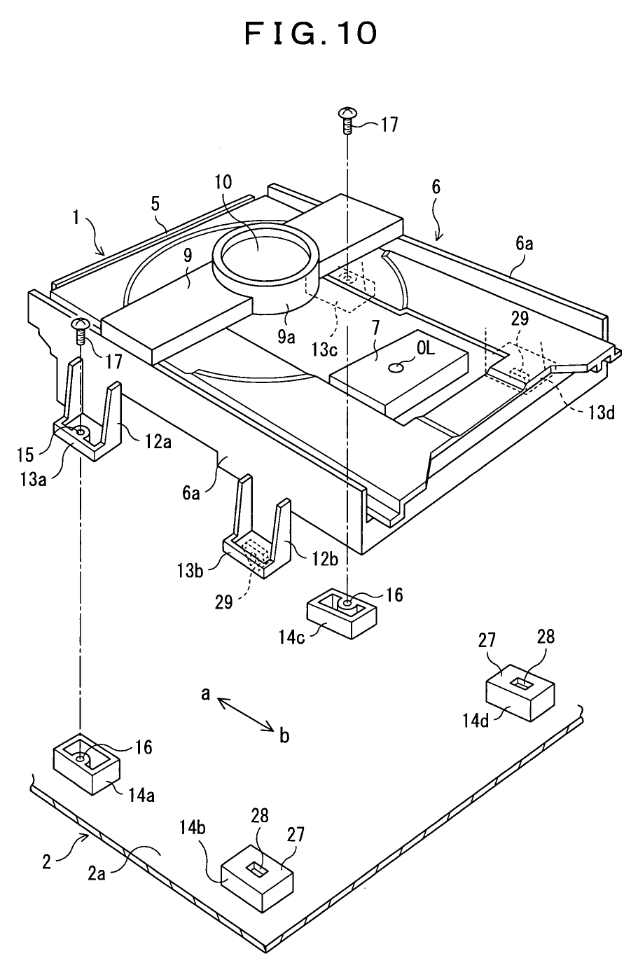

FIGS. 9 to 11 show a disc device according to a fourth embodiment of the present invention. In this disc device, two rear side supporting stands 14b and 14d of the four supporting stands 14a to 14d integrally provided on the bottom chassis 2a to project therefrom, are provided with a top plates 27 which is formed with an engaging through hole 28 of a rectangular shape. Engaging pieces 29 are integrally provided on the bottom surfaces of the rear side foot portions 13b and 13d to project therefrom at the positions such that the engaging pieces 29 oppose the engaging through holes 28 when the foot portions 13a to 13d are brought into contact with the supporting stands 14a to 14d with predetermined relative positions such as with the foot portions 13a to 13d being in alignment with the supporting stands 14a to 14d. The third embodiment has substantially the same configuration as that of the first embodiment shown in FIGS. 1 to 4 except the above mentioned structure. Accordingly, the same or like reference numerals and marks are used for the same or similar elements in the drawing of the embodiment and description of substantially the same configuration will be omitted for the convenience.

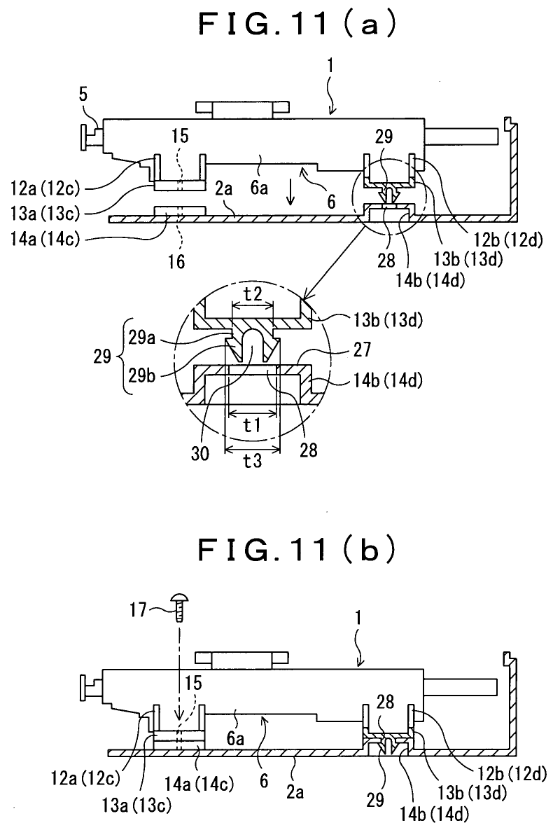

As shown in the enlarged view of FIG. 11 (a), each of the engaging pieces 29 is composed of a proximal portion 29a having a size t2 in the back to forth direction which is equal to or a little smaller than the size t1 of the engaging through hole 28 in the back to forth direction, and a hook portion 29b bifurcated into a pair of branches which extend downward with a slit therebetween, and which are elastically deflectable. Each of the branches has an end portion tapered toward its end to have a shape of a spade, an arrowhead or spearhead. The dimension t3 between the outermost projected ends of the end portions of the branches is larger than the size t1 of the engaging through hole 28 in the back to forth direction. The width of each hook portions 29 (the dimension of the hook portion in the direction perpendicular to the plane of the drawing) is equal to or a little smaller than the width of the engaging through hole 28.

Next, explanation will be made of a process for assembling the disc device of the configuration as described above. As shown in FIG. 11(a), the disc device main body 1 is lowered to bring the engaging pieces 29 close to engaging through holes 28. When the disc device main body 1 is pressed down further as shown in FIG. 11(b), the branches 29b of each engaging piece 29 elastically deflects with the branches coming close to each other, and the end portions of the branches engage each engaging through hole 28, and the foot portions 13a to 13d are mounted on the supporting stands 14a to 14d. Subsequently, screws 17 are passed though the through holes 15 of the front side foot portions 13a and 13c and threaded into the screw holes 16 of the front side supporting stands 14a and 14c to fix the disc device main body 1 at a predetermined position in the housing 2.

According to the above mentioned configuration, the number of the screws 17 is reduced from that of the conventional device by the number of engaging pieces 29 and engaging through holes 28 so that manufacturing cost of the disc device is reduced and efficiency of assembling work is improved.

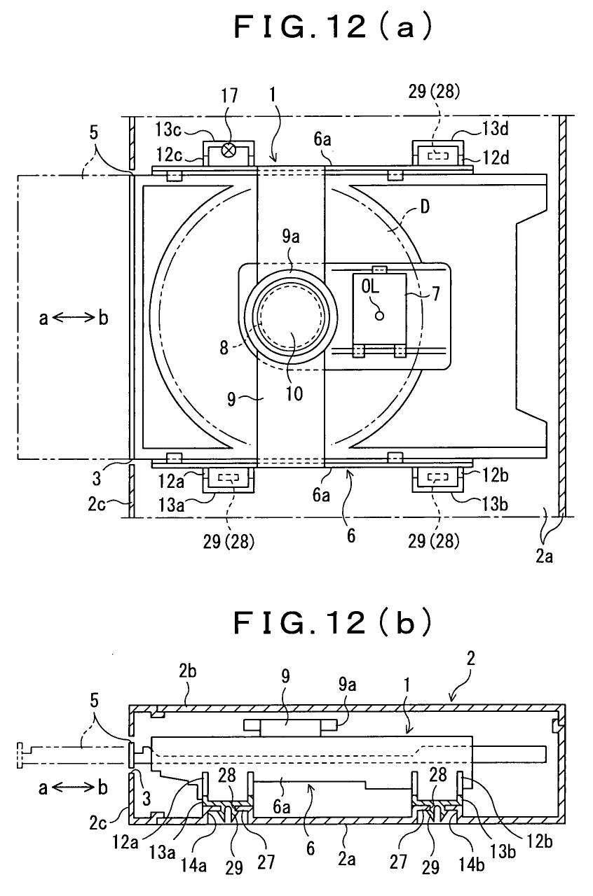

Although the disc device main body 1 of the above-mentions fourth embodiment is fixed at a predetermined position in the housing 2 by two engaging through holes 28 and engaging pieces 29 and two screws 17, the manner of the fixing is not limited to this. As shown in FIG. 12, another top plate 27 formed with an engaging through hole 28 may be provided on one of the supporting stands 14a and 14c and an engaging piece 29 may be integrally provided on one of the front side foot portions 13a and 13c to project therefrom so that the disc device main body 1 may be fixed at predetermined position within the housing 2 by means of three engaging through holes and three engaging pieces and one screw. According to this configuration, only one screw is required for the fixing of the disc device main body so that manufacturing cost is further reduced and efficiency of assembling work is further improved. (fifth embodiment)

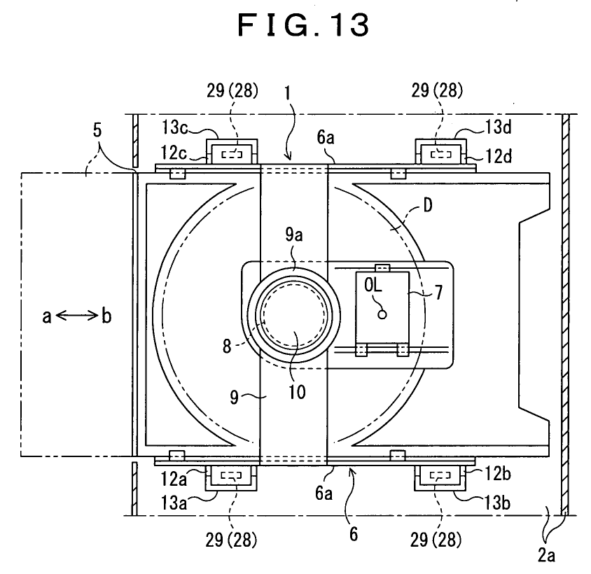

In addition, as shown in FIG. 13, the top plates 27 formed with an engaging through hole may be provided respectively on both front side supporting stands 14a and 14c and engaging pieces 29 may be integrally provided respectively on both front side foot portions 13a and 13c to project therefrom such that the disc device main body 1 is fixed at a predetermined position in the housing 2 by means of four engaging through holes 28 and four engaging pieces 29. According to this configuration, no screw (as seen in FIG. 9) is used for fixing the disc device main body 1 to the housing 2 as in the case of the third embodiment (see FIGS. 6 to 8), thereby further reducing the manufacturing cost and improving the efficiency of assembling work. (Sixth embodiment)

According to one aspect of the above-mentioned embodiments of the present invention, a disk device comprises a disc device main body for reproducing data from, recording data to and/or erasing data from a disk and including a loader chassis of synthetic resin material and four leg portions provided on the loader chassis integrally therewith, each of the leg portion having a foot portion bent at right angle at the distal end of the leg portion and the leg portions being spaced from each other by predetermined distances and projecting from the loader chassis; and a housing of synthetic resin material adapted for accommodating the disc device main body and including a bottom chassis integrally provided with four supporting stands projecting from the bottom chassis to be respectively engaged by and coupled to the foot portions to fix the disc device main body to the housing, wherein at least two of the four couplings of the foot portions and supporting stands are configured in a form of retaining coupling with which one of the foot portion and the supporting stand is fit into the other with relative movement of the disc device main body and the housing, to retain the foot portion in the supporting stand. The retaining coupling may take various forms, although not limited to, such as of a structure wherein the foot portions are respectively inserted into spaces formed between the supporting stands and the horizontal plates of the L-shaped engaging pieces each of which is composed of a vertical plate provided on the bottom chassis integrally therewith to project therefrom in the vicinity of the supporting plate and a horizontal plate bent at right angle from the distal end of the vertical plate and extending over the supporting stand, a structure wherein elastically deformable or deflectable hooks are provided in the vicinity of the supporting stands and each of the hooks is formed with a projecting end to which the foot portion is pressed down to pass over the projecting end and to be engaged by the hook, or the structure where top plates formed with an engaging through hole are fixed on the supporting tables and engaging pieces are provided integrally on the foot portions to project therefrom such that the foot portions are mounted on the supporting stand with the engaging pieces respectively disengageably engaging the engaging through holes to fix the disc device main body at predetermined position in the housing.

According to the above mentioned configuration, the number of the screws is reduced from that of the conventional device by the number of the retaining couplings so that manufacturing cost of the disc device is reduced and efficiency of assembling work is improved.

According to another aspect of the embodiments, a disk device comprises a disc device main body for reproducing data from, recording data to and/or erasing data from a disk and including a loader chassis of synthetic resin material and four leg portions provided on the loader chassis integrally therewith, each of the leg portion having a foot portion bent at the distal end of the leg portion at right angle and the leg portions being spaced from each other by predetermined distances and projecting from the loader chassis; and a housing of synthetic resin material for accommodating the disc device main body, and including a bottom chassis integrally provided with four supporting stands projecting from the bottom chassis to be respectively engaged by the foot portions, wherein L-shaped engaging pieces each having a vertical plate integrally provided on the bottom chassis to project therefrom and a horizontal plate bent at right angle at the distal end of the vertical plate are respectively provided in the vicinities of at least two of the four supporting stands with the spacing between the bottom surface of the horizontal plate and the top surface of the supporting stand being substantially equal to the thickness of the foot portion such that the foot portions fit in the spaces between the horizontal plates and the supporting tables when the foot portions are put on and slid over the supporting stands, and the rest of the supporting stands is formed with a screw hole into which a screw is threaded after passed through a through hole formed in the foot portion mounted on the supporting stand, whereby the disc device main body is fixed at a predetermined position within the housing.

This feature is derived from the first and second embodiments wherein the foot portions of the disc device main body are put on the supporting stands and slid over the supporting stands to allow the foot portions to engage respective engaging pieces and a screw is threaded into a screw hole of the supporting stand after passed through the through hole of the foot portion, thereby fixing the disc device main body at a predetermined position within the housing. Thus, the number of the screws is reduced from that of the conventional device by the number of engaging pieces and engaging through holes so that manufacturing cost of the disc device is reduced and efficiency of assembling work is improved.

According to still another aspect of the embodiments, a disk device comprises a disc device main body for reproducing data from, recording data to and/or erasing data from a disk and including a loader chassis of synthetic resin material and four leg portions provided on the loader chassis integrally therewith, each of the leg portion having a foot portion bent at the distal end of the leg portion at right angle and the leg portions being spaced from each other by predetermined distances and projecting from the loader chassis; and a housing of synthetic resin material for accommodating the disc device main body, and including a bottom chassis integrally provided with four supporting stands projecting from the bottom chassis to be respectively engaged by the foot portions wherein four elastically deformable hooks are provided on the bottom chassis integrally therewith to project therefrom respectively in the vicinities of the four supporting stands such that the foot portions are pressed against projecting tips of the hooks to elastically displace the hooks and push past the projecting tips and that the foot portions are mounted on the supporting stands with the projecting tips engaging the foot portions, and wherein the projecting tips of the hooks project over the supporting stands and the spacing between each projecting tip and each supporting stand is set to be equal to the thickness of each foot portion.

This feature is derived from the third embodiment shown in FIGS. 6 to 8. According to this configuration, the foot portions of the disc device main body push past the hooks and are mounted on the supporting stands with the projecting tips of the hooks engaging the foot portions to fix the disc device main body at predetermined position within the housing. Thus, the configuration requires no screw for the fixing so that manufacturing cost of the disc device is reduced and efficiency of assembling work is improved.

According to yet another aspect of the embodiments, a disk device comprises a disc device main body for reproducing data from, recording data to and/or erasing data from a disk and including a loader chassis of synthetic resin material and four leg portions provided on the loader chassis integrally therewith, each of the leg portion having a foot portion bent at the distal end of the leg portion at right angle and the leg portions being spaced from each other by predetermined distances and projecting from the loader chassis; and a housing of synthetic resin material for accommodating the disc device main body, and including a bottom chassis integrally provided with four supporting stands projecting from the bottom chassis to be respectively engaged by the foot portions wherein top plates formed with an engaging through hole are fixed to at least two of four supporting stands and engaging pieces are integrally provided on the supporting stands that are to abut against the supporting stands having the engaging through hole, such that the engaging pieces elastically engage the engaging through holes, while the rest of the supporting stands are formed with a screw hole into which a screw is threaded after extending through a through hole formed in the foot portion with the foot portions mounted on the supporting stands.

This feature is derived from the fourth and fifth embodiments shown in FIGS. 9 to 12. With this feature, the number of the screws is reduced from that of the conventional device by the number of the engaging through holes and engaging pieces so that manufacturing cost of the disc device is reduced and efficiency of assembling work is improved.

According to still further aspect of the embodiments, a disk device comprises a disc device main body for reproducing data from, recording data to and/or erasing data from a disk and including a loader chassis of synthetic resin material and four leg portions provided on the loader chassis integrally therewith, each of the leg portion having a foot portion bent at the distal end of the leg portion at right angle and the leg portions being spaced from each other by predetermined distances and projecting from the loader chassis; and a housing of synthetic resin material for accommodating the disc device main body and including a bottom chassis integrally provided with four supporting stands projecting from the bottom chassis to be respectively engaged by the foot portions, wherein top plates formed with an engaging through hole are fixed to four supporting stands and engaging pieces are integrally provided on four supporting stands such that the engaging pieces elastically engage the engaging through holes with the foot portions being mounting on the supporting stands to fix the disc device main body at a predetermined position within the housing.

This feature is derived from sixth embodiments shown in FIG. 13. With this feature, no screw is required for the fixing like as in the case of the third embodiment so that manufacturing cost of the disc device is reduced and efficiency of assembling work is improved.

What is claimed is:

1. A disk device comprising:
a disc device main body for reproducing data from, recording data to and/or erasing data from a disk and including a loader chassis of synthetic resin material and four leg portions provided on the loader chassis integrally therewith, each of the leg portion having a foot portion bent at the distal end of the leg portion at right angle and the leg portions being spaced from each other by predetermined distances and projecting from the loader chassis; and
a housing of synthetic resin material for accommodating the disc device main body, and including a bottom chassis provided with four supporting stands to be respectively engaged by the foot portions, the disc device main body being fixed at a predetermined position within the housing with the foot portions on the bottom chassis being restrained respectively on the supporting stands; and
wherein L-shaped engaging pieces each having a vertical plate integrally provided on the bottom chassis to project therefrom and a horizontal plate bent at right angle from the distal end of the vertical plate are respectively provided in the vicinities of at least two of the four supporting stands with the spacing between the bottom surface of the horizontal plate and the top surface of the supporting stand being substantially equal to the thickness of the foot portion such that the foot portions fit in the spaces between the horizontal plates and the supporting tables when the foot portions are slid over the supporting stands, and the rest of the supporting stands is formed with a screw hole into which a screw is threaded after passed through a through hole formed in the foot portion mounted on the supporting stand, whereby the disc device main body is fixed at a predetermined position within the housing.

2. A disk device comprising:
a disc device main body for reproducing data from, recording data to and/or erasing data from a disk and including a loader chassis of synthetic resin material and four leg portions provided on the loader chassis integrally therewith, each of the leg portion having a foot portion bent at the distal end of the leg portion at right angle and the leg portions being spaced from each other by predetermined distances and projecting from the loader chassis; and
a housing of synthetic resin material for accommodating the disc device main body, and including a bottom chassis integrally provided with four supporting stands projecting from the bottom chassis to be respectively engaged by the foot portions, the disc device main body being fixed at a predetermined position within the housing with the foot portions on the bottom chassis being restrained respectively on the supporting stands and
wherein four elastically deformable hooks are provided on the bottom chassis integrally therewith to project therefrom respectively in the vicinities of the four supporting stands such that the foot portions are pressed against projecting tips of the hooks to elastically displace the hooks and push past the projecting tips and that the foot portions are mounted on the supporting stands with the projecting tips engaging the foot portions, and wherein the projecting tips of the hooks project over the supporting stands and the spacing between each projecting tip and each supporting stand is set to be equal to the thickness of each foot portion.

3. A disk device comprising:
a disc device main body for reproducing data from, recording data to and/or erasing data from a disk and including a loader chassis of synthetic resin material and four leg portions provided on the loader chassis integrally therewith, each of the leg portion having a foot portion bent at the distal end of the leg portion at right angle and the leg portions being spaced from each other by predetermined distances and projecting from the loader chassis; and
a housing of synthetic resin material for accommodating the disc device main body, and including a bottom chassis integrally provided with four supporting stands projecting from the bottom chassis to be respectively engaged by the foot portions, the disc device main body being fixed at a predetermined position within the housing with the foot portions on the bottom chassis being restrained respectively on the supporting stands;
wherein top plates formed with an engaging through hole are fixed to at least two of four supporting stands and engaging pieces are integrally provided on the supporting stands that are to abut against the supporting stands having the engaging through hole, such that the engaging pieces elastically engage the engaging through holes, while the rest of the supporting stands are formed with a screw hole into which a screw is threaded after extending through a through hole formed in the foot portion with the foot portions mounted on the supporting stands.

4. A disk device comprising
a disc device main body for reproducing data from, recording data to and/or erasing data from a disk and including a loader chassis of synthetic resin material and four leg portions provided on the loader chassis integrally therewith, each of the leg portion having a foot portion bent at the distal end of the leg portion at right angle and the leg portions being spaced from each other by predetermined distances and projecting from the loader chassis; and
a housing of synthetic resin material for accommodating the disc device main body, and including a bottom chassis integrally provided with four supporting stands projecting from the bottom chassis to be respectively engaged by the foot portions, the disc device main body being fixed at a predetermined position within the housing with the foot portions on the bottom chassis being restrained respectively on the supporting stand and
wherein top plates formed with an engaging through hole are fixed to four supporting stands and engaging pieces are integrally provided on four supporting stands such that the engaging pieces elastically engage the engaging through holes with the foot portions being mounting on the supporting stands to fix the disc device main body at a predetermined position within the housing

5. A disk device according the claim 4, wherein each engaging piece includes a proximate portion having a back-to-forth size equal to or a little smaller than that of the engaging through hole, and elastically displaceable hook portion bifurcated into two branches extending downward with a slit therebetween.

6. A disk device comprising
a disc device main body for reproducing data from, recording data to and/or erasing data from a disk and including a loader chassis of synthetic resin material and four leg portions provided on the loader chassis integrally therewith, each of the leg portion having a foot portion bent at the distal end of the leg portion at right angle and the leg portions being spaced from each other by predetermined distances and projecting from the loader chassis; and
a housing of synthetic resin material for accommodating the disc device main body, and including a bottom chassis provided with four supporting stands extending from the bottom chassis to be respectively engaged by and coupled to the foot portions to fix the disc device main body to the housing, the disc device main body being fixed at a predetermined position within the housing with the foot portions on the bottom chassis being restrained respectively on the supporting stands;
wherein at least two of the four couplings of the foot portions and supporting stands are configured in a form of retaining coupling with which one of the foot portion and the supporting stand is fit into the other with relative movement of the disc device main body and the housing, to retain the foot portion in the supporting stand.
